(19) United States
(12) Patent Application Publication
(10) Pub. No.: US 2022/0174436 A1
(43) Pub. Date: Jun. 2, 2022

(54) METHOD FOR CALCULATING GAIN IN A HEARING AID

(71) Applicant: Oticon A/S, Smørum (DK)

(72) Inventors: Hamish INNES-BROWN, Smørum (DK); Emina ALICKOVIC, Smørum (DK); Martin ENQVIST, Linköping (SE)

(73) Assignee: Oticon A/S, Smørum (DK)

(21) Appl. No.: 17/523,311

(22) Filed: Nov. 10, 2021

(30) Foreign Application Priority Data
Nov. 30, 2020 (EP) 20210765.2
Jan. 15, 2021 (EP) 21151755.2

(51) Int. Cl. H04R 25/00

(52) U.S. Cl. CPC H04R 25/606; H04R 25/505

(57) ABSTRACT

A method for calculating gain in a hearing aid includes: recording electrical activity of the brain in response to a sound signal, computing a temporal response function based on the recorded activity, comparing the computed temporal response function with a template temporal response function, and calculating a gain in the hearing aid based on the difference between the computed temporal response function and the template temporal response function.

### SUMMARY

The present invention relates to the field of hearing aids.

In order to estimate the gain needed in order to restore audibility to a given hearing-impaired person, a hearing device needs to know what frequency-specific gains to apply. These gain values are usually found by estimating a person's frequency-specific hearing thresholds behaviorally via an audiogram. The hearing threshold values are then used as an input to a fitting rule to determine the amplification needed at each frequency. However, devices cannot determine these gain values themselves in order to provide frequency-specific normal loudness sensation during normal usage. Thus, there is a need for improvements.

### A Hearing Aid

In an aspect of the present application, a hearing aid is provided, in which the gain is calculated by recording electrical activity of the brain in response to a sound signal, computing an intensity-dependant spectro-temporal response function (hereafter equivalently named a ‘temporal response function’) based on the recorded activity, comparing the computed temporal response function with a template temporal response function, and then calculating the gain in the hearing aid based on the difference between the computed temporal response function and the template temporal response function. An advantage of this is that the hearing aid user will have an automatically fitted hearing aid which can provide better hearing results without having to visit a practitioner. Since the template temporal response function is initially calculated using controlled sounds that vary from threshold to loud, gain parameters can be derived that could control loudness sensation—taking into account the expected brain response to both loud and quiet sounds.

For simplicity, this application will refer to the broad-band TRF and the frequency-specific spectro-temporal response function, STRF interchangeably. In practice however, a filter bank would be used to calculate a frequency-dependent model or STRF. This would allow for all calculated measures and gain control parameters to be frequency-specific.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may comprise a number of electrodes of a cochlear implant (for a CI type hearing aid) or a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound. The wireless receiver may e.g. be configured to receive an electromagnetic signal in the radio frequency range (3 kHz to 300 GHz). The wireless receiver may e.g. be configured to receive an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally The generalized sidelobe canceller (GSC) structure is an equivalent representation of the MVDR beamformer offering computational and numerical advantages over a direct implementation in its original form.

The hearing aid may comprise antenna and transceiver circuitry (e.g. a wireless receiver) for wirelessly receiving a direct electric input signal from another device, e.g. from an entertainment device (e.g. a TV-set), a communication device, a wireless microphone, or another hearing aid. The direct electric input signal may represent or comprise an audio signal and/or a control signal and/or an information signal. The hearing aid may comprise demodulation circuitry for demodulating the received direct electric input to provide the direct electric input signal representing an audio signal and/or a control signal e.g. for setting an operational parameter (e.g. volume) and/or a processing parameter of the hearing aid. In general, a wireless link established by antenna and transceiver circuitry of the hearing aid can be of any type. The wireless link may be established between two devices, e.g. between an entertainment device (e.g. a TV) and the hearing aid, or between two hearing aids, e.g. via a third, intermediate device (e.g. a processing device, such as a remote control device, a smartphone, etc.). The wireless link may be used under power constraints, e.g. in that the hearing aid may be constituted by or comprise a portable (typically battery driven) device. The wireless link may be a link based on near-field communication, e.g. an inductive link based on an inductive coupling between antenna coils of transmitter and receiver parts. The wireless link may be based on far-field, electromagnetic radiation. The communication via the wireless link may be arranged according to a specific modulation scheme, e.g. an analogue modulation scheme, such as FM (frequency modulation) or AM (amplitude modulation) or PM (phase modulation), or a digital modulation scheme, such as ASK (amplitude shift keying), e.g. On-Off keying, FSK (frequency shift keying), PSK (phase shift keying), e.g. MSK (minimum shift keying), or QAM (quadrature amplitude modulation), etc.

The communication between the hearing aid and the other device may be in the base band (audio frequency range, e.g. between 0 and 20 kHz). Preferably, communication between the hearing aid and the other device is based on some sort of modulation at frequencies above 100 kHz. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology).

The hearing aid may be or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g.

The hearing aid may comprise a forward or signal path between an input unit (e.g. an input transducer, such as a microphone or a microphone system and/or direct electric input (e.g. a wireless receiver)) and an output unit, e.g. an output transducer. The signal processor may be located in the forward path. The signal processor may be adapted to provide a frequency dependent gain according to a user's particular needs. The hearing aid may comprise an analysis path comprising functional components for analyzing the input signal (e.g. determining a level, a modulation, a type of signal, an acoustic feedback estimate, etc.). Some or all signal processing of the analysis path and/or the signal path may be conducted in the frequency domain. Some or all signal processing of the analysis path and/or the signal path may be conducted in the time domain.

An analogue electric signal representing an acoustic signal may be converted to a digital audio signal in an analogue-to-digital (AD) conversion process, where the analogue signal is sampled with a predefined sampling frequency or rate f_{S}, f_{S} being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/f_{S}, e.g. 50 μs, for ƒ_{S}=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry comprise(s) a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal The TF conversion unit may comprise a Fourier transformation unit for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate f_{S} is larger than or equal to twice the maximum frequency fₘₐₓ, f_{S}≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of

a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);

b) the current acoustic situation (input level, feedback, etc.), and

c) the current mode or state of the user (movement, temperature, cognitive load, etc.);

d) the current mode or state of the hearing aid (program selected, time elapsed since last user interaction, etc.) and/or of another device in communication with the hearing aid.

The classification unit may be based on or comprise a neural network, e.g. a rained neural network.

The hearing aid may comprise an acoustic (and/or mechanical) feedback control (e.g. suppression) or echo-cancelling system. Acoustic feedback occurs because the output loudspeaker signal from an audio system providing amplification of a signal picked up by a microphone is partly returned to the microphone via an acoustic coupling through the air or other media. The part of the loudspeaker signal returned to the microphone is then re-amplified by the system before it is re-presented at the loudspeaker, and again returned to the microphone. As this cycle continues, the effect of acoustic feedback becomes audible as artifacts or even worse, howling, when the system becomes unstable. The problem appears typically when the microphone and the loudspeaker are placed closely together, as e.g. in hearing aids or other audio systems. Some other classic situations with feedback problems are telephony, public address systems, headsets, audio conference systems, etc. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The feedback control system may comprise a feedback estimation unit for providing a feedback signal representative of an estimate of the acoustic feedback path, and a combination unit, e.g. a subtraction unit, for subtracting the feedback signal from a signal of the forward path (e.g. as picked up by an input transducer of the hearing aid). The feedback estimation unit may comprise an update part comprising an adaptive algorithm and a variable filter part for filtering an input signal according to variable filter coefficients determined by said adaptive algorithm, wherein the update part is configured to update said filter coefficients of the variable filter part with a configurable update frequency f_{upd}. The hearing aid may be configured to provide that the configurable update frequency f_{upd} has a maximum value f_{upd,max}. The maximum value f_{upd,max} ,ay be a fraction of a sampling frequency f_{S} of an AD converter of the hearing aid (f_{upd,max}=f_{S}/D).

The update part of the adaptive filter may comprise an adaptive algorithm for calculating updated filter coefficients for being transferred to the variable filter part of the adaptive filter. The timing of calculation and/or transfer of updated filter coefficients from the update part to the variable filter part may be controlled by the activation control unit. The timing of the update (e.g. its specific point in time, and/or its update frequency) may preferably be influenced by various properties of the signal of the forward path. The update control scheme is preferably supported by one or more detectors of the hearing aid, preferably included in a predefined criterion comprising the detector signals.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. The hearing assistance system may comprise a speakerphone (comprising a number of input transducers and a number of output transducers, e.g. for use in an audio conference situation), e.g. comprising a beamformer filtering unit, e.g. providing multiple beamforming capabilities.

### A Method

In an aspect of the present invention, a method for calculating gain in a hearing aid is provided. The method comprises the steps of recording electrical activity of the brain in response to a sound signal, computing a temporal response function based on the recorded activity, comparing the computed temporal response function with a template temporal response function, and calculating a gain in the hearing aid based on the difference between the computed temporal response function and the template temporal response function. This allows for hearing aids to determine automatic gain values during everyday use without the need of a practitioner.

According to another aspect of the present invention, there is provided a method for calculating gain further comprising the step of extracting a sound intensity estimate from the sound signal, wherein the step of computing a temporal response function based on the recorded activity further comprises basing the temporal response function also on the sound intensity estimate. An advantage of this is that the computed temporal response function will take both time and intensity into consideration, thus allowing for a more accurate result.

According to another aspect, there is provided a method for calculating frequency-specific gains in a hearing aid, the method further comprising the step of: extracting a sound intensity estimate from the sound signal, wherein the step of computing a spectro-temporal response function based on the recorded activity further comprises basing the temporal response function also on the frequency content of the sound signal. An advantage of this is that a set of frequency-specific gains can be calculated

According to another aspect of the present invention, the step of recording electrical activity of the brain comprises recording electrical activity with electrodes placed on the hearing aid (such as in the ear canal, on the receiver assembly), and/or on the scalp of a user wearing the hearing aid.

According to another aspect of the present invention, the step of computing the temporal response function, and /or step of calculating a gain is performed in an external device in wired or wireless communication with the hearing aid.

According to another aspect of the present invention, the sound signal is a continuous acoustic signal. An advantage of this is that the method allows for continuous everyday use, and is not reliant on a controlled sound signal produced in a controlled environment over a short time range with given properties such as intensity or frequency.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

More generally, a hearing aid comprises an input transducer for receiving an acoustic signal from a user's surroundings and providing a corresponding input audio signal and/or a receiver for electronically (i.e. wired or wirelessly) receiving an input audio signal, a (typically configurable) signal processing circuit (e.g. a signal processor, e.g. comprising a configurable (programmable) processor, e.g. a digital signal processor) for processing the input audio signal and an output unit for providing an audible signal to the user in dependence on the processed audio signal. The signal processor may be adapted to process the input signal in the time domain or in a number of frequency bands. In some hearing aids, an amplifier and/or compressor may constitute the signal processing circuit. The signal processing circuit typically comprises one or more (integrated or separate) memory elements for executing programs and/or for storing parameters used (or potentially used) in the processing and/or for storing information relevant for the function of the hearing aid and/or for storing information (e.g. processed information, e.g. provided by the signal processing circuit), e.g. for use in connection with an interface to a user and/or an interface to a programming device. In some hearing aids, the output unit may comprise an output transducer, such as e.g. a loudspeaker for providing an air-borne acoustic signal or a vibrator for providing a structure-borne or liquid-borne acoustic signal In some hearing aids, the output unit may comprise one or more output electrodes for providing electric signals (e.g. to a multi-electrode array) for electrically stimulating the cochlear nerve (cochlear implant type hearing aid).

In some hearing aids, the vibrator may be adapted to provide a structure-borne acoustic signal transcutaneously or percutaneously to the skull bone. In some hearing aids, the vibrator may be implanted in the middle ear and/or in the inner ear. In some hearing aids, the vibrator may be adapted to provide a structure-borne acoustic signal to a middle-ear bone and/or to the cochlea. In some hearing aids, the vibrator may be adapted to provide a liquid-borne acoustic signal to the cochlear liquid, e.g. through the oval window. In some hearing aids, the output electrodes may be implanted in the cochlea or on the inside of the skull bone and may be adapted to provide the electric signals to the hair cells of the cochlea, to one or more hearing nerves, to the auditory brainstem, to the auditory midbrain, to the auditory cortex and/or to other parts of the cerebral cortex.

A h hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a temporal response function.

FIG. 2A shows a manual fitting process,

FIG. 2B shows an automatic fitting process,

FIG. 3 shows a method for calculating gain according to the invention.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

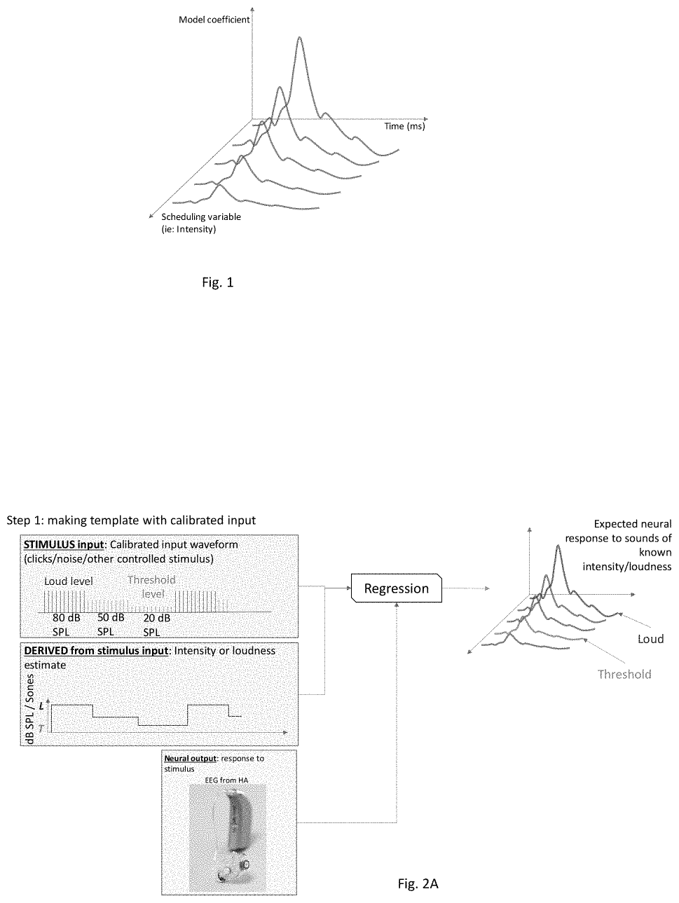

FIG. 1 shows an example of a so-called temporal response function (TRF). A temporal response function shows the level of neural response over a short time range for a given intensity and frequency of input sound (the frequency axis has been omitted for clarity). In order to compute a neural spectro-temporal response function, the hearing aid can use neural recordings of brainstem activity generated in response to continuous sound input in everyday usage. The spectro-temporal response function measured continuously during everyday usage can then be compared with a template spectro-temporal response function that was generated in an initial fitting where the sound input was controlled. The gains needed could then be computed via an optimization process which continuously minimizes the difference between the template and the measured spectro-temporal response functions. The temporal response function shown in FIG. 1 is derived from one possible modelling approach in which the model varies according to a scheduling variable that is extracted from the stimulus waveform. While the model is drawn with lines here, in fact it would be a surface. Including a frequency axis would transform this TRF into a spectro-temporal response function (STRF). This axis is not shown here for graphical simplicity. As previously stated, for simplicity, this application will refer to the broad-band TRF and the frequency-specific spectro-temporal response function, STRF interchangeably. In practice however, a filter bank would be used to calculate a frequency-dependent model or STRF. This would allow for all calculated measures and gain control parameters to be frequency-specific.

Auditory brainstem responses (ABRs) are traditionally derived by averaging EEG recordings that are generated in response to thousands of repeated transient stimuli. When collected in this manner, the relationships between stimulus intensity and the amplitude and latency of the ABR peaks have been well characterized. This allows ABRs to be used as an objective measure for estimating hearing thresholds as well as for other diagnostic parameters. Neural responses similar to the ABR can be extracted from EEG recorded in response to continuous natural speech stimuli, rather than repeated presentations of simple, transient sounds. Thus, hearing devices with the capacity to measure EEG may be able to compute ABR-like responses from an analysis of the on-going EEG in combination with a continuous acoustic signal such as a processed microphone signal or the hearing aid output signal. Thus, this allows hearing assessments to be performed automatically by hearing aids. However, this still requires the speech stimulus to be delivered in blocks of fairly constant amplitude, because the currently-used linear modelling framework used to estimate the responses has an assumption that the stimulus is fixed in amplitude over time, and that the fixed-amplitude stimulus generates a similarly fixed-amplitude response. Such modelling frameworks generate a single model (TRF; STRF) for a given segment of speech, even though most speech (and other environmental sounds) are in fact signals with inherent variations in amplitude that occur over multiple time-scales. TRFs generated from continuous speech are more useful if they are able to use the inherent amplitude fluctuations contained in speech in order to generate a set of TRFs, or a TRF that contained a dimension that varied with stimulus amplitude. Thus, a hearing device with EEG capabilities would be able to compute a set of TRFs (or a TRF that contained a dimension linked to stimulus intensity) for a variety of environmental sound levels. This would enable a hearing device according to the invention to determine whether the user's auditory system was responding to certain levels of sound continuously and during every-day usage, without controlling the listening environment.

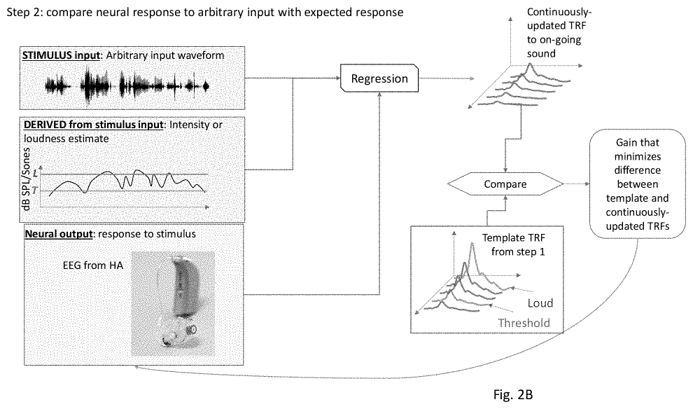

FIG. 2A shows a manual fitting process, in which an initial model is generated under optimal and controlled conditions, and is then subsequently used for continuous verification and fine adjustment. In the scenario illustrated in FIG. 2A, controlled stimuli are played (either in free field, or directly produced via the hearing aid), and the model is generated along with behavioral responses that indicate the threshold and comfortably-loud levels. The hearing aid shown in FIG. 2A can either have electrodes built-in, or be in communication with scalp electrodes places on the user's head. Once the model is generated during the clinical fitting process, it is used as a template during every day usage, and a gain control signal is derived from a continuous process of minimizing the difference between the model and the continuously-calculated TRF, as is illustrated in FIG. 2B. According to the automatic fitting process shown in FIG. 2B, the device has a model (or could be thought of as a transfer function) for the expected neural response that should occur for components of input sounds across multiple frequency bands and sound intensity levels. In this way, the gain can be controlled so that sounds are not only audible, but of the expected perceptual loudness across the entire range of input intensities. One of the purposes of the invention is to help ensure that gains are applied taking into account both the ‘loud’ and ‘threshold’ levels (FIGS. 2A and 2B). This would help ensure good ‘loudness growth’—that soft sounds sound soft, and loud sounds sound loud.

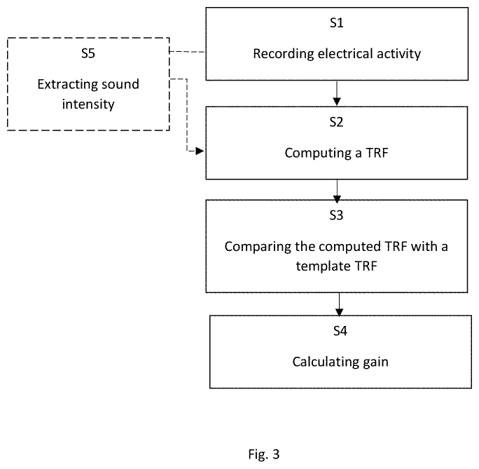

FIG. 3 shows a method for calculating gain according to the invention. In the first step, electrical activity of the brain is recorded S1, using either scalp EEG, or electrodes built-in to the hearing aid. The electrical activity is preferably recorded continuously during everyday use of the hearing aid. The recorded activity is in response to continuous acoustic signals with varying properties (intensity, frequency etc) that occur during normal use. The sound signal can be the processed microphone signal or the hearing aid output signal. A temporal response function TRF is computed S2 based on the recorded activity. In some embodiments, a sound intensity estimate can be extracted S5 from the sound signal (e.g. either the microphone input or the processed hearing aid output). This intensity estimate can be used as additional input when computing S2 the TRF describing the expected neural output as a function of both time and intensity. In step S3, the computed TRF is compared with a template TRF. The template TRF is generated during a manual clinical fitting process such as described in FIG. 2A. The gain can ultimately be calculated S4 based on the difference between the computed temporal response function and the template temporal response function. The gains needed could for example be calculated via an optimization process which continuously minimizes the difference between the template and the measured (computed) TRFs. It is to be noted that any of the calculating steps could be performed in an external device, such as a smartphone, in wired or wireless communication with the hearing aid. Additionally the hearing aid may interphase remotely with a brain signal acquisition device and process the brain signals acquired from a separate system.

It is further possible, that a hearing aid is initially fit with zero (or very low) gain. For a totally self-fitting device, frequency-specific gains could be slowly increased until the expected frequency component of the calculated TRF becomes statistically significant. Alternatively in a user-aided fitting, the device user could indicate themselves via a smartphone or similar interface when certain sounds become audible and when they reach a ‘comfortably loud’ level. There is also the possibility to create an initial estimate of gains based on other auditory evoked potentials like onset potentials (N1-P2 complex) or auditory steady state responses (ASSR).

In either case, a model is generated similarly to FIG. 2A, and can be used to control the hearing device in the same way. If a statistical significance test is used, only the ‘threshold’ levels will be available, but the dynamic range can be estimated using an existing fitting rationale.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A method for calculating gain in a hearing aid, comprising the steps of:
recording electrical activity of the brain in response to a sound signal,
computing a temporal response function based on the recorded activity,
comparing the computed temporal response function with a template temporal response function, and calculating a gain in the hearing aid based on the difference between the computed temporal response function and the template temporal response function.

2. A method for calculating gain in a hearing aid according to claim 1, the method further comprising the step of:
extracting a sound intensity estimate from the sound signal, wherein the step of computing a temporal response function based on the recorded activity further comprises basing the temporal response function also on the sound intensity estimate.

3. A method for calculating frequency-specific gains in a hearing aid according to claim 1, the method further comprising the step of:
extracting a sound intensity estimate from the sound signal, wherein the step of computing a spectro-temporal response function based on the recorded activity further comprises basing the temporal response function also on the frequency content of the sound signal.

4. A method for calculating gain in a hearing aid according to claim 1, wherein the step of recording electrical activity of the brain comprises recording electrical activity with electrodes placed on the hearing aid, and/or on the scalp of a user wearing the hearing aid.

5. A method for calculating a gain in a hearing aid according to claim 1, wherein the step of computing the temporal response function, and /or step of calculating a gain is performed in an external device in wired or wireless communication with the hearing aid.

6. A method for calculating a gain in a hearing aid according to claim 1, wherein the sound signal is a continuous acoustic signal.

7. A hearing aid in which the gain is calculated according to claim 1.

8. A method for calculating gain in a hearing aid according to claim 2, wherein the step of recording electrical activity of the brain comprises recording electrical activity with electrodes placed on the hearing aid, and/or on the scalp of a user wearing the hearing aid.

9. A method for calculating gain in a hearing aid according to claim 3, wherein the step of recording electrical activity of the brain comprises recording electrical activity with electrodes placed on the hearing aid, and/or on the scalp of a user wearing the hearing aid.

10. A method for calculating a gain in a hearing aid according to claim 2, wherein the step of computing the temporal response function, and/or step of calculating a gain is performed in an external device in wired or wireless communication with the hearing aid.

11. A method for calculating a gain in a hearing aid according to claim 3, wherein the step of computing the temporal response function, and /or step of calculating a gain is performed in an external device in wired or wireless communication with the hearing aid.

12. A method for calculating a gain in a hearing aid according to claim 4, wherein the step of computing the temporal response function, and /or step of calculating a gain is performed in an external device in wired or wireless communication with the hearing aid.

13. A method for calculating a gain in a hearing aid according to claim 2, wherein the sound signal is a continuous acoustic signal.

14. A method for calculating a gain in a hearing aid according to claim 3, wherein the sound signal is a continuous acoustic signal.

15. A method for calculating a gain in a hearing aid according to claim 4, wherein the sound signal is a continuous acoustic signal.

16. A method for calculating a gain in a hearing aid according to claim 5, wherein the sound signal is a continuous acoustic signal.

17. A hearing aid in which the gain is calculated according to claim 2.

18. A hearing aid in which the gain is calculated according to claim 3.

19. A hearing aid in which the gain is calculated according to claim 4.

20. A hearing aid in which the gain is calculated according to claim 5.
